(19) United States
(12) Patent Application Publication
(10) Pub. No.: US 2013/0312661 A1
(43) Pub. Date: Nov. 28, 2013

(54) BARRIER TYPE DEPOSITION APPARATUS

(71) Applicants: YU-CHIU SHIH, Taichung (TW); HSIU-PO LIU, Taichung (TW)

(72) Inventors: YU-CHIU SHIH, Taichung (TW); HSIU-PO LIU, Taichung (TW)

(73) Assignee: GCSOL TECH CO., LTD., Taichung (TW)

(21) Appl. No.: 13/550,320

(22) Filed: Jul. 16, 2012

(30) Foreign Application Priority Data
May 22, 2012 (TW) 101118223

(51) Int. Cl. C03C 17/00

(52) U.S. Cl. CPC C03C 17/001
USPC 118/500

(57) ABSTRACT

A barrier type deposition apparatus has a barrier in a closed chamber of a base to separate the chamber into two depositing rooms. The deposition apparatus may deposits a thin film on a side of a glass substrate, which is a part of the deposition apparatus. While the barrier is another glass substrate, it may deposit two different thin films respectively on opposite sides of the glass substrate in the same time.

### BACKGROUND OF THE INVENTION

1. Field of the Invention

The present invention relates generally to a device for depositing thin films, and more particularly to a barrier type deposition apparatus to deposit a thin film on single side of a glass substrate or two different thin films on opposite sides of the glass substrate.

2. Description of the Related Art

In conventional art for depositing thin films on a glass substrate, a conventional method is putting the glass substrate in a container filled with specified chemical solution to form thin films on opposite sides of the glass substrate through a chemical reaction under a specified time and temperature. At this time, the thin films on both sides of the glass substrate are the same so that it has to remove the thin film from one side of the glass substrate, and then deposit a new thin film on it when it needs two different thin films on the opposite sides of the glass substrate. It is clear that it has complex procedures and takes a long time to make a glass substrate with two different thin films on the opposite sides thereof in the conventional method.

Another conventional method for making glass substrate with two different thin films on the opposite sides thereof is to form a new thin film directly on the thin film which has been already formed on one side of the glass substrate in the previous step. However, it still has the same problem as described above.

### SUMMARY OF THE INVENTION

The primary objective of the present invention is to provide a barrier type deposition apparatus, which has at least two isolated depositing rooms to deposit a thin film on single side of a glass substrate or two different thin films on opposite sides of the glass substrate.

According to the objective of the present invention, the present invention provides a barrier type deposition apparatus, including at least a frame having an opening which is open at a left side and a right side of the frame; a plurality of glass substrates respectively provided on the left side and the right side of the frame to close the opening; and at least a barrier board received in the opening of the frame to divide the opening into two isolated depositing rooms so that each glass substrate has a side in the depositing room.

The present invention further provides a barrier type deposition apparatus, including a base having a closed chamber therein; and at least a first glass substrate received in the chamber to divide the chamber into at least two isolated depositing rooms, wherein opposite sides of the first glass substrate respectively are in the depositing rooms.

Therefore, the closed chamber is divided into two isolated depositing rooms to deposit a thin film on single side of each glass substrate. It also may deposit two different thin films on opposite sides of the glass substrate while the barrier board is replaced by a glass substrate.

### BRIEF DESCRIPTION OF THE DRAWINGS

FIG. 1 is an exploded view of a first preferred embodiment of the present invention;

FIG. 2 is a perspective view of the first preferred embodiment of the present invention;

FIG. 3 is a sectional view in the 3-3 line of FIG. 2;

FIG. 4 is a lateral view of FIG. 3;

FIG. 5 is a perspective view of a second preferred embodiment of the present invention;

FIG. 6 is a perspective view of a third preferred embodiment of the present invention;

FIG. 7 is a perspective view of a fourth preferred embodiment of the present invention;

FIG. 8 is similar to FIG. 4, showing a fifth preferred embodiment of the present invention;

FIG. 9 is a perspective view of a sixth preferred embodiment of the present invention; and

FIG. 10 is a perspective view of a seventh preferred embodiment of the present invention.

### DETAILED DESCRIPTION OF THE INVENTION

In order to achieve the purpose of depositing a thin film on single side of a glass substrate or two different thin films on opposite sides of the glass substrate, the barrier type deposition apparatus provides at least two independent depositing rooms. The detailed description and technical contents of the present invention will be explained with reference to the accompanying drawings. However, the drawings are illustrative only but not used to limit the present invention.

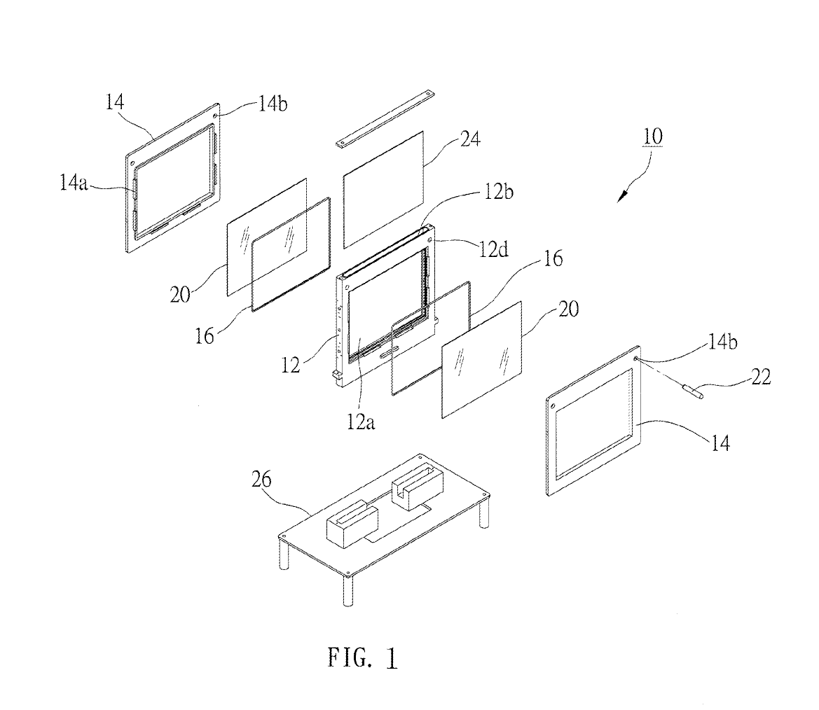

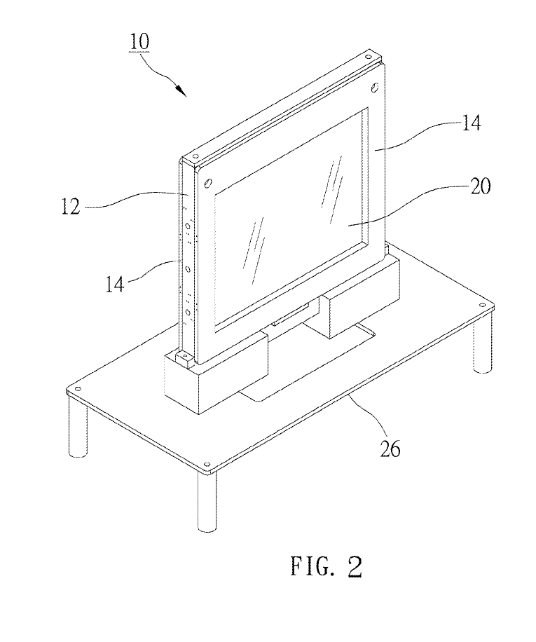

As shown in FIG. 1 to FIG. 3, a barrier type deposition apparatus of the first preferred embodiment of the present invention includes a base, two sealing members 16, two glass substrate 20, and a barrier board 24.

The base includes a rectangle frame 12 and two lateral boards 14.

The frame 12 has an opening 12a, and the opening 12a is open at right and left sides thereof. The frame 12 has an elongated slot 12b at a top thereof to communicate the opening 12a. The frame 12 respectively has a slot 12c at the right and the left sides surrounding the openings 12a to receive the sealing members 16 therein. The sealing members 16 are flexible.

Each lateral board 14 has a plurality of protrusions 14a at an inner side thereof, and the protrusions 14a are arranged in a U-shaped layout to form a clip slot. The glass substrate 20 engages the clip slot to be held by the protrusions 14a. Each lateral board 14 has at least a bore 14b, and the frame 12 has at least a bore 12d. At least a pin 22 is inserted into the bores 14b and 12d of the lateral boards 14 and the frame 12 to fix the lateral boards 14 to the left and right sides of the frame 12. At the same time, the sealing members 16 respectively press the glass substrates 20, and the glass substrates 20 close the left and right open ends of the opening 12a to form a closed chamber in the frame 12. An alternate way to secure the frame 12 and the lateral boards 14 is by bolt and nut, or by bolt and threaded hole. It may use a clamping member (not shown) to hold the frame 12 and the lateral boards 14 as well.

The barrier board 24 is inserted into the chamber 12a of the frame 12 through the slot 12b to divide the chamber 12a into two isolated depositing room S1, S2. The inner sides of the glass substrates 20 respectively are in the depositing room 51, S2. In an embodiment, the frame 12 is provided with a slot 12e on a sidewall of the chamber 12a and the slot 12b to receive an edge of the barrier board 24. In an embodiment, the glass substrate 20 and the barrier board 24 are parallel.

In operation of the present invention, the deposition apparatus 10 is mounted on a holder 26. The steps of depositing a thin film on single side of the glass substrate 20 include:

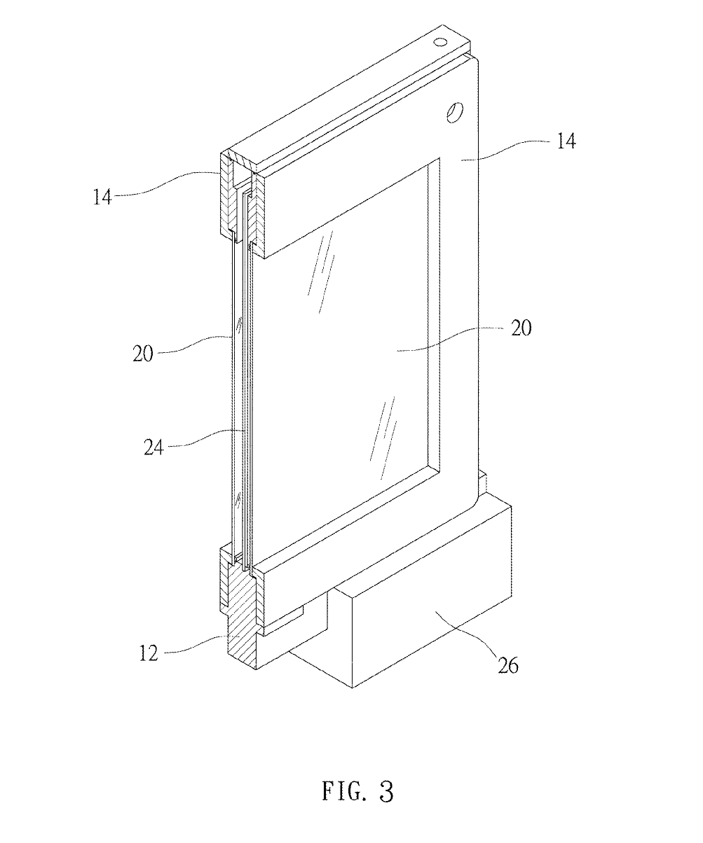

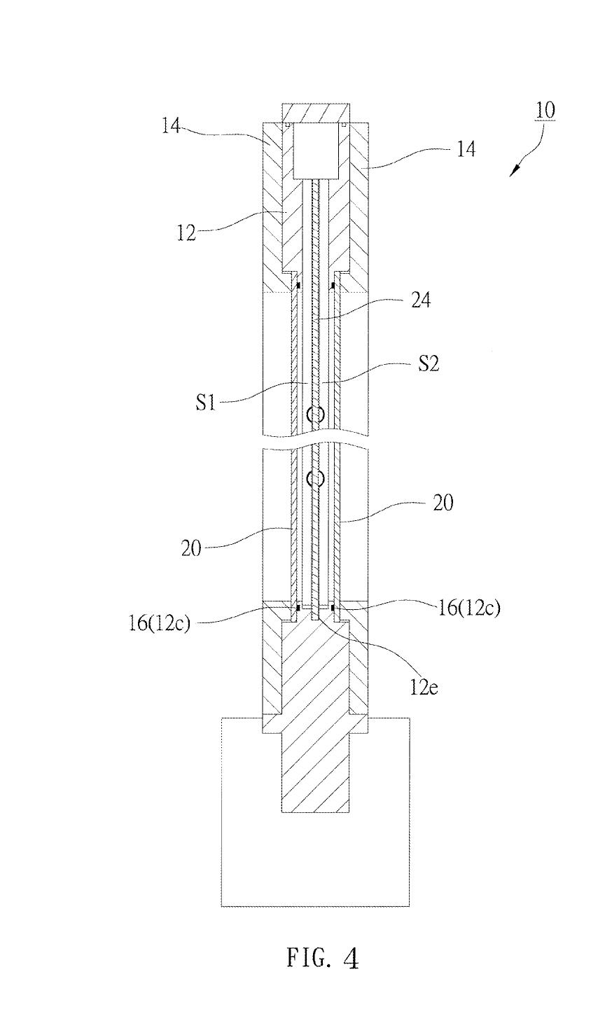

As shown in FIG. 3 and FIG. 4, specified chemical solution respectively is poured into the depositing room S1, S2. The inner sides of the glass substrates 20 are in contact with the chemical solution to respectively deposit a thin film on it through a chemical reaction under a controlled time and temperature. It is easy to understand that the thin films on the glass substrates 20 are the same while the chemical solutions in the depositing rooms S1, S2 are the same, and it will get different thin films on the glass substrates 20 while the chemical solutions in the depositing rooms S1, S2 are different. In an embodiment, the frame 12 is provided with an inlet and an outlet to pour the chemical solution into the depositing rooms and to exhaust chemical solution out. In an embodiment, only one hole on the frame 12 to serve the function of the inlet and the outlet.

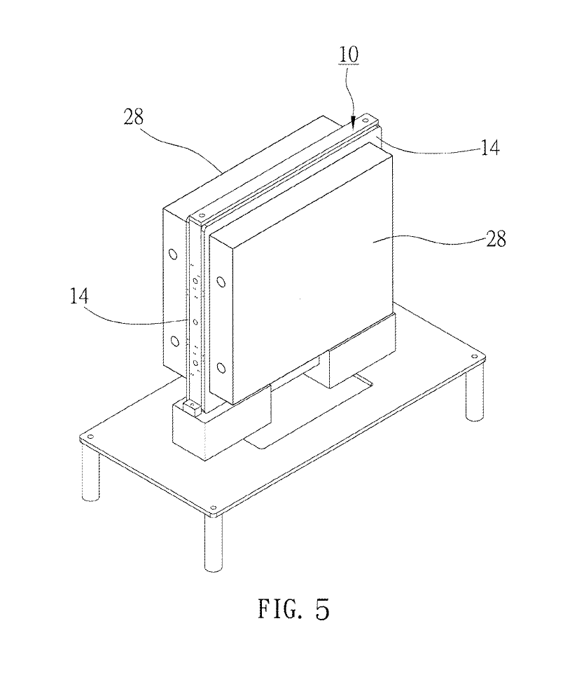

As shown in FIG. 5, a deposition apparatus of the second preferred embodiment of the present invention further includes two temperature controllers 28 on outer sides of the lateral boards 14 or on the glass substrates 20 to control the temperature of the chemical reaction in the depositing rooms. The temperature controllers 28 may provide hot air or cold air to the depositing rooms to change the temperature therein.

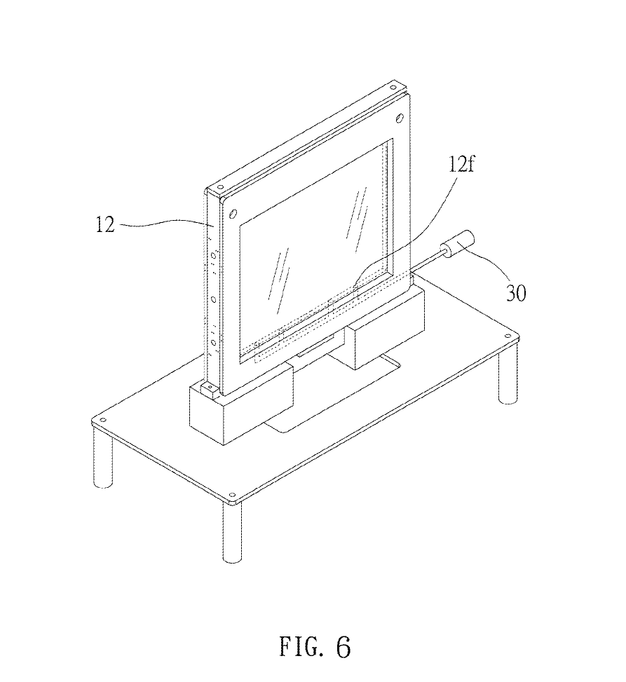

As shown in FIG. 6, a deposition apparatus of the third preferred embodiment of the present invention further includes a turbulence generator. The turbulence generator includes a plurality of air bores 12f on a bottom of the frame 12. This air bores 12f are connected to an air compressor (not shown) through a hose to supply air into the depositing rooms. The air makes turbulence in the chemical solution to make the thin film deposited on the glass having an even thickness.

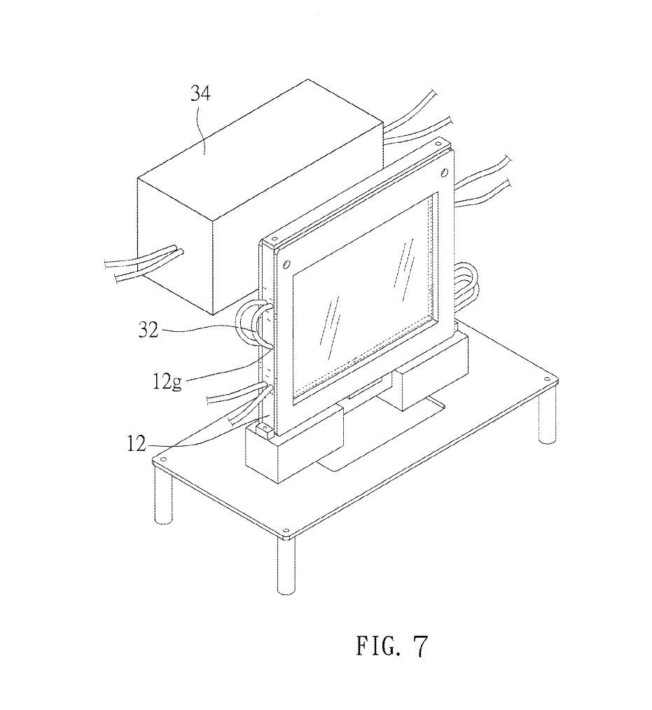

As shown in FIG. 7, a deposition apparatus of the fourth preferred embodiment of the present invention further includes a turbulence generator. The turbulence generator includes a plurality of bores 12g on lateral sides of the frame 12 which are communicated with the depositing rooms, hoses 32 connected to the bores 12g, and a circulating device 34 connected to the hoses 34. The circulating device 34 provides compressed chemical solutions to the depositing rooms through the hoses 32. The chemical solution keeps circulation in the chemical reaction to achieve the same purpose of the third preferred embodiment.

The following description is how to deposit different thin films on opposite sides the glass substrate.

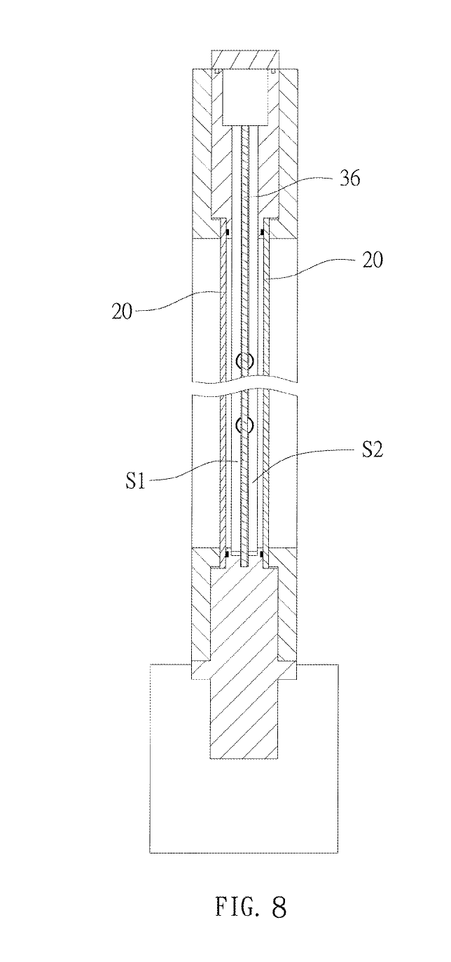

As shown in FIG. 8, a glass substrate 36 is inserted into the chamber 12a of the frame 12 through the slot 12b to replace the barrier board 24. Different chemical solutions are poured into the depositing rooms S1, S2 so that opposite sides of the glass substrate 36 respectively are in contact with the different chemical solutions in the depositing rooms S1, S2. After specified chemical reactions in the depositing rooms S1, S2, the glass substrate 36 is formed with different thin films on opposite sides thereof. In an embodiment, if two glass substrates 20 are mounted on the lateral boards 14, the glass substrates 20 will be formed with different thin films on single side of each glass substrate in the same time.

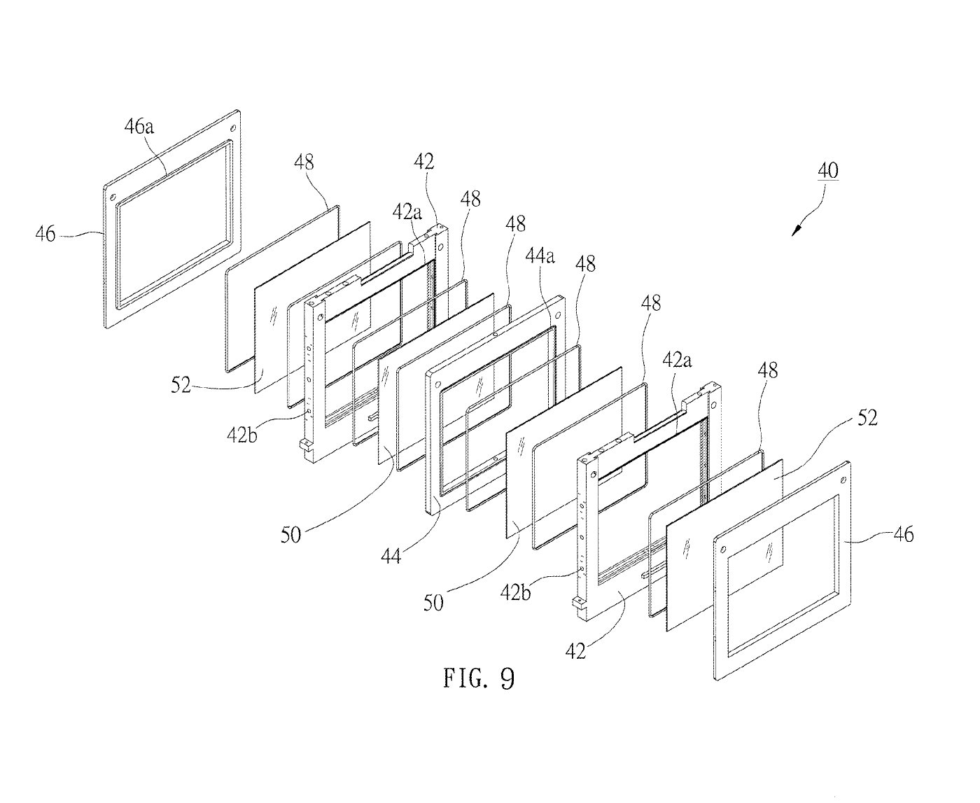

FIG. 9 shows a deposition apparatus 40 of the sixth preferred embodiment of the present invention, which includes a base, a plurality of sealing members 48, two first glass substrates 50, and two second glass substrates 52.

The base has two frames 42 with the same shape, a connecting frame 44, and two lateral boards 46. The frames 42 and the connecting frame 44 respectively have an opening and a slot 42a, 44a surrounding the opening. The sealing members 48 respectively are received in the slots 42a, 44a. Each lateral board 46 has a protrusion 46a at an inner side surrounding the opening. As shown in FIG. 9, the connecting frame 44 is between the frames 42, and the lateral boards 46 respectively are mounted on outer sides of the frames 42. The second glass substrates 52 respectively are between the frames 42 and the lateral boards 46, and the first glass substrates 50 respectively are between the connecting frame 44 and the frames 42.

The connecting frame 44, the frames 42 and the lateral boards 46 are secured together by the same way as described above. The protrusions 46a of the lateral boards 46 press the corresponding second glass substrates 52 to make the sealing members 48 to press the first and the second glass substrates 50, 52, and therefore, a depositing room is formed in each frame 42 between the first and the second glass substrates 50, 52. Chemical solution is poured into the depositing rooms to form thin films on the sides of the first and second glass substrates 50, 52 in contact with the chemical solution. Chemical solution may be poured into the depositing rooms through inlets 42b on the frames 42, but not limited only.

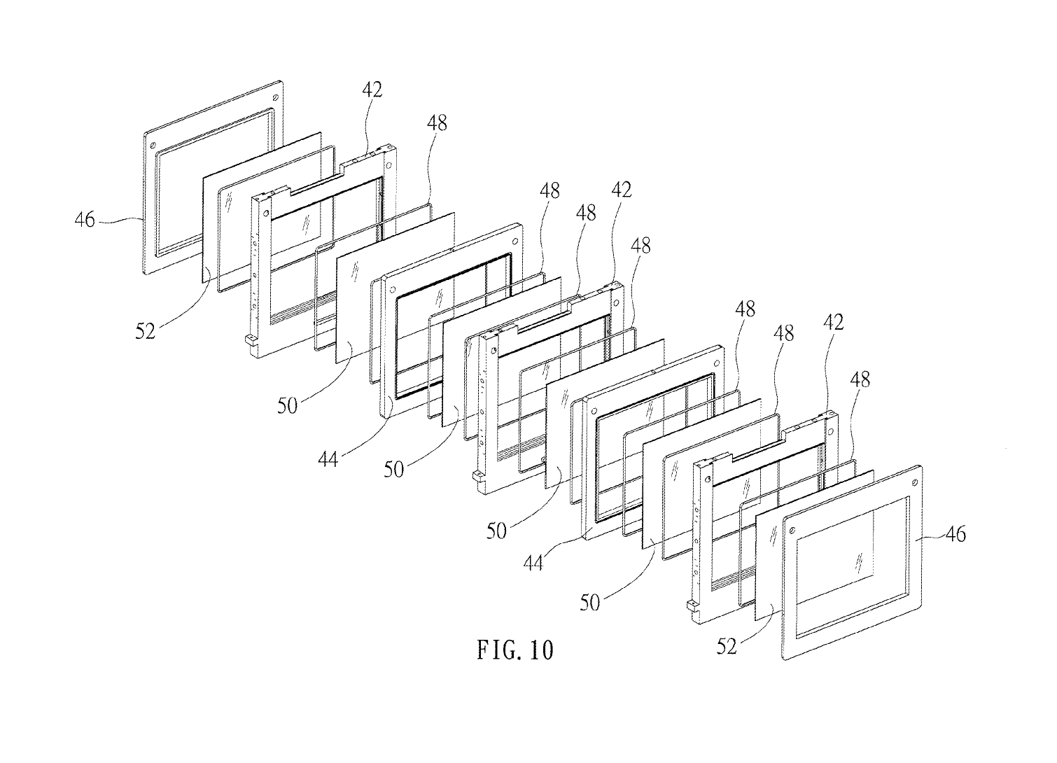

FIG. 10 shows a deposition apparatus of the seventh preferred embodiment of the present invention, which has several sets of the frames 42, the connecting frame 44, the sealing members 48, and the first and the second glass substrates 50, 52 between a pair of the lateral boards 46. It is clear that more glass substrates may be formed with thin films at the same time.

In the embodiments, chemical solution is used to be the reaction medium to form the thin film. In practice, gas may be the reaction medium also. It has to keep the depositing rooms in an airtight condition when use the gas reaction medium.

The description above is a few preferred embodiments of the present invention and the equivalence of the present invention is still in the scope of claim construction of the present invention.

What is claimed is:

1. A barrier type deposition apparatus, comprising:
at least a frame having an opening which is open at a left side and a right side of the frame;
a plurality of glass substrates respectively provided on the left side and the right side of the frame to close the opening; and
at least a barrier board received in the opening of the frame to divide the opening into two isolated depositing rooms so that each glass substrate has a side in the depositing room.

2. The barrier type deposition apparatus as defined in claim 1, further comprising two lateral boards respectively fixed to the left side and the right side of the frame, wherein the glass substrates are between the frame and the lateral boards.

3. The barrier type deposition apparatus as defined in claim 2, further comprising two sealing members between the frame and the glass substrates, wherein the sealing members respectively are provided on the left side and the right side of the frame surrounding the opening of the frame.

4. The barrier type deposition apparatus as defined in claim 3, further comprising at least a connecting frame, wherein the barrier type deposition apparatus has a plurality of the frames; the connecting frame is between the frames; the lateral boards respectively are connected to outer sides of the frames; the glass substrates are between the frames and the lateral boards and between the frames and the connecting frame; and the sealing members are between the glass substrates and the frames and between the glass substrate and the connecting frame.

5. The barrier type deposition apparatus as defined in claim 3, wherein each of the lateral boards is provided with a plurality of protrusions in a predetermined layout to form a clip slot, and the glass substrate engages the clip slot.

6. The barrier type deposition apparatus as defined in claim 1, wherein the frame has a slot communicated with the opening so that the glass substrate is inserted into the opening through the slot.

7. The barrier type deposition apparatus as defined in claim 1 wherein the barrier board is a glass substrate.

8. The barrier type deposition apparatus as defined in claim 1, further comprising at least a temperature controller on an outer side of the glass substrate.

9. The barrier type deposition apparatus as defined in claim 1, further comprising a turbulence generator to provide turbulence in reaction medium in the depositing rooms.

10. A barrier type deposition apparatus, comprising:
a base having a closed chamber therein; and
at least a first glass substrate received in the chamber to divide the chamber into at least two isolated depositing rooms, wherein opposite sides of the first glass substrate respectively are in the depositing rooms.

11. The barrier type deposition apparatus as defined in claim 10, wherein the base includes a frame having an opening and two lateral boards fixed to opposite sides of the frame to close opposite ends of the opening and form the chamber.

12. The barrier type deposition apparatus as defined in claim 11, further comprising at least a second glass substrate between the lateral board and the frame, wherein a side of the second glass substrate is in the depositing room.

13. The barrier type deposition apparatus as defined in claim 12, further comprising at least a connecting frame and a plurality of sealing members, wherein the barrier type deposition apparatus has a plurality of the frames, the first glass substrates and the second glass substrates; the connecting frame is between two of the frames; the lateral boards respectively are connected to outer sides of the frames; the second glass substrates respectively are between the lateral boards and the frames; the first glass substrates respectively are between the connecting frame and the frames; and the sealing members respectively are between the first glass substrates and the connecting frames and between the second glass substrates and the frames.

14. The barrier type deposition apparatus as defined in claim 10, further comprising at least a temperature controller on an outer side of the base.

15. The barrier type deposition apparatus as defined in claim 10, further comprising a turbulence generator to provide turbulence in reaction medium in the depositing rooms.
